(19) United States
(12) Patent Application Publication
(10) Pub. No.: US 2012/0017513 A1
(43) Pub. Date: Jan. 26, 2012

(54) GATE BRACE

(76) Inventors: Ryan P. LEHMANN, Lancaster, PA (US); Richard A. REGGIO, Carmel, NY (US)

(21) Appl. No.: 13/186,584

(22) Filed: Jul. 20, 2011

Related U.S. Application Data
(60) Provisional application No. 61/367,156, filed on Jul. 23, 2010.

(51) Int. Cl. E06B 11/02; F16B 1/00; E04B 1/00

(52) U.S. Cl. 49/381; 49/506; 403/403

(57) ABSTRACT

A brace includes a first body configured and disposed to secure ends of adjacent structural members together, the brace having a substantially triangular shape.

### RELATED APPLICATION

This application claims priority to U.S. Provisional Patent Application Ser. No. 61/367,156, filed Jul. 23, 2010, entitled “Gate Gusset Corner Brace.”

### FIELD OF THE DISCLOSURE

The present disclosure generally relates to support apparatus and, more particularly, to support apparatus for use with structural members, such as fencing systems.

### BACKGROUND

Walk gates for known fencing systems are typically composed of 2″×4″ (also offered in 2″×6″) PVC profiles that are welded together. Welded gates are susceptible to failure at the weld. Moisture infiltrates the weld and can freeze. The moisture expands upon freezing, resulting in failure of the weld. Once the welds fail, the gate must be replaced, which is costly and inconvenient.

Thus, there is a need and a desire for a fence system and components relating thereto having increased durability in all operating environments.

### SUMMARY

The present disclosure relates to a brace including a first body configured and disposed to secure ends of adjacent structural members together, the brace having a substantially triangular shape.

The present disclosure further relates to a brace wherein the first body includes retention features formed therein to secure ends of adjacent members together.

The present disclosure additionally relates to a brace wherein at least one fastening device extends through an opening formed in the first body, the at least one fastening device configured and disposed to engage adjacent structural members secured by the first body.

The present disclosure yet further relates to a brace wherein the first body includes at least two flanges disposed at a predetermined angle from each other to guide ends of adjacent structural members together.

The present disclosure still yet further relates to a brace wherein two flanges of the at least two flanges substantially correspond to a leg of the substantially triangular shape of the first body.

The present disclosure further relates a brace wherein the predetermined angle between the at least two flanges is about 90 degrees.

The present disclosure yet further relates to a brace wherein a first surface of the first body abuts a first surface of each of adjacent structural members.

The present disclosure still further relates to a brace wherein a second surface of the first body abuts a second surface of at least one structural member of adjacent structural members.

The present disclosure still yet further relates to a brace wherein a first surface of a second body abuts a third surface of each of adjacent structural members.

The present disclosure further relates to a brace wherein the second body includes at least one fastening device extending through an opening formed in the second body, the at least one fastening device configured and disposed to engage adjacent structural members secured by the second body.

The present disclosure yet further relates to a brace wherein the third surface is opposite the first surface of each of adjacent structural members.

The present disclosure still yet further relates to a brace wherein adjacent structural members form a portion of a frame of a gate.

The present disclosure further relates to a brace wherein the first body includes a hinge portion.

The present disclosure still further relates to a fence system including a gate having a plurality of structural members, the gate pivotably connectable to a post. At least one brace is secured to at least two structural members of the plurality of structural members. The at least one brace includes a body configured and disposed to secure ends of the at least two structural members together, the at least one brace having a substantially triangular shape.

The present disclosure still yet further relates to a fence system wherein at least one brace of the at least one brace includes a hinge portion.

The present disclosure further relates to a method for reinforcing a fence gate that includes providing at least one brace and securing ends of at least two adjacent structural members of a frame of the gate to the at least one brace.

The present disclosure still further relates to a method that includes guiding the at least one brace to a position for securing ends of at least two adjacent structural members of a frame of the gate using a guide feature formed in the at least one brace.

The present disclosure still yet further relates to a method for securing ends includes securing ends of at least two adjacent structural members of a frame of the gate to the at least one brace, the at least one brace comprising a first body and an opposed second body.

The present disclosure further relates to a method wherein the fence gate is selected from a group including vinyl, wood, plastic, composite, aluminum, steel, and PVC.

The present disclosure yet further relates to a method wherein securing ends includes inserting at least one fastening device through an opening formed in the at least one brace, the at least one fastening device configured and disposed to engage adjacent structural members positioned in the at least one brace.

An advantage of the present disclosure is a gate that substantially prevents sagging despite corner seam weld failure.

Other features and advantages of the present disclosure will be apparent from the following more detailed description of the preferred embodiment, taken in conjunction with the accompanying drawings which illustrate, by way of example, the principles of the invention.

Numerous other features and advantages of the present disclosure will become readily apparent from the following detailed description, the accompanying drawings, and the appended claims.

### BRIEF DESCRIPTION OF THE DRAWINGS

FIG. 1 is an upper perspective view of exemplary embodiment of a brace of the present disclosure.

FIG. 2 is a lower perspective view of the brace of FIG. 1 of the present disclosure.

FIG. 3 is a side view of the brace of FIG. 1 of the present disclosure.

FIG. 4 is an opposed perspective view of the brace of FIG. 1 of the present disclosure.

FIG. 5 is an opposed side view of the brace of FIG. 4 of the present disclosure.

FIG. 6 is a perspective view of the brace of FIG. 4 rotated about an axis, of the present disclosure.

FIG. 7 is an end view of the brace of FIG. 6 of the present disclosure.

FIG. 8 is a lower perspective view of an arrangement of braces securing adjacent structural members together, of the present disclosure.

FIG. 9 is an upper perspective view of an alternate embodiment of a brace of the present disclosure.

FIG. 10 is an alternate embodiment of a brace of the present disclosure.

FIG. 11 is a partial perspective view of a fence system utilizing a brace of the present disclosure.

FIG. 12 is a lower perspective view of an alternate embodiment of a brace of the present disclosure.

FIG. 13 is an alternate arrangement of adjacent structural members secured by a brace of the present disclosure.

### DETAILED DESCRIPTION

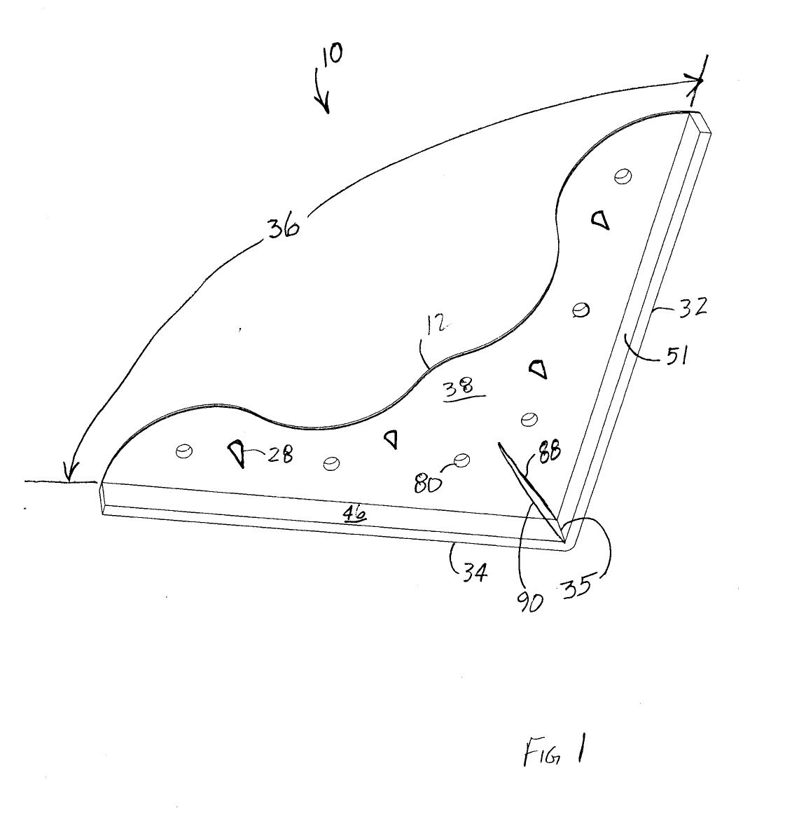

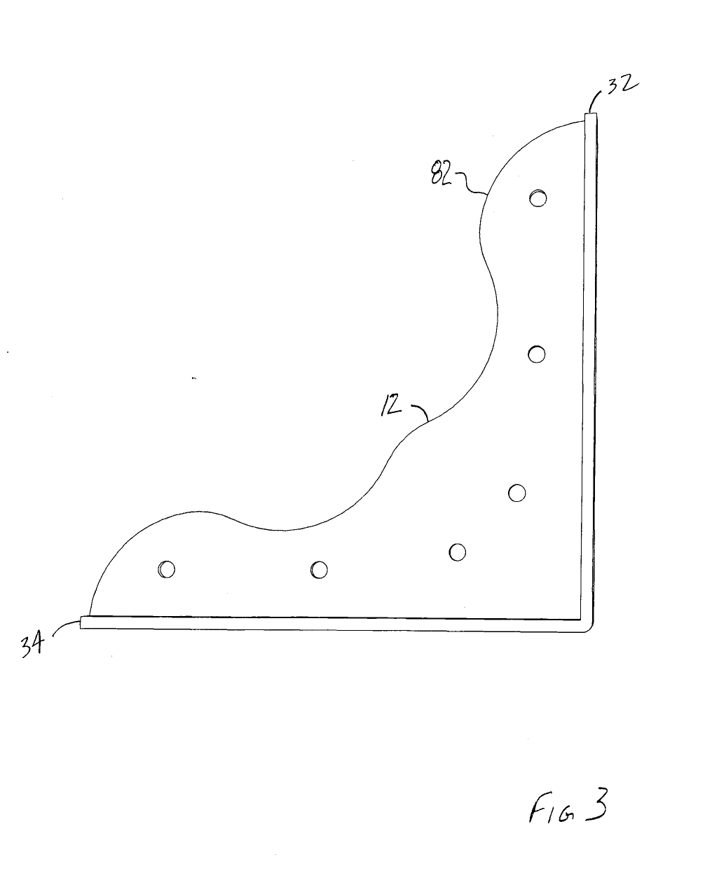

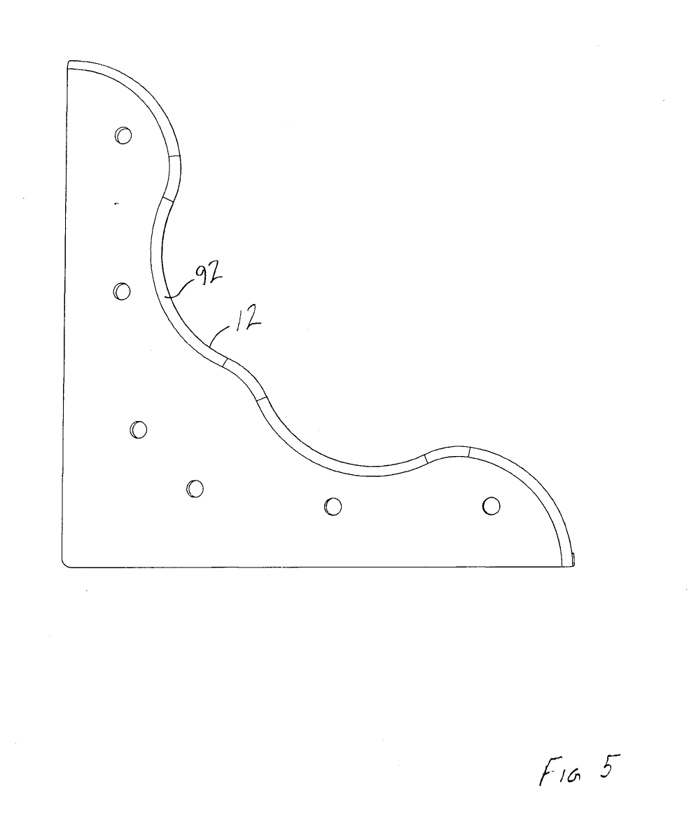

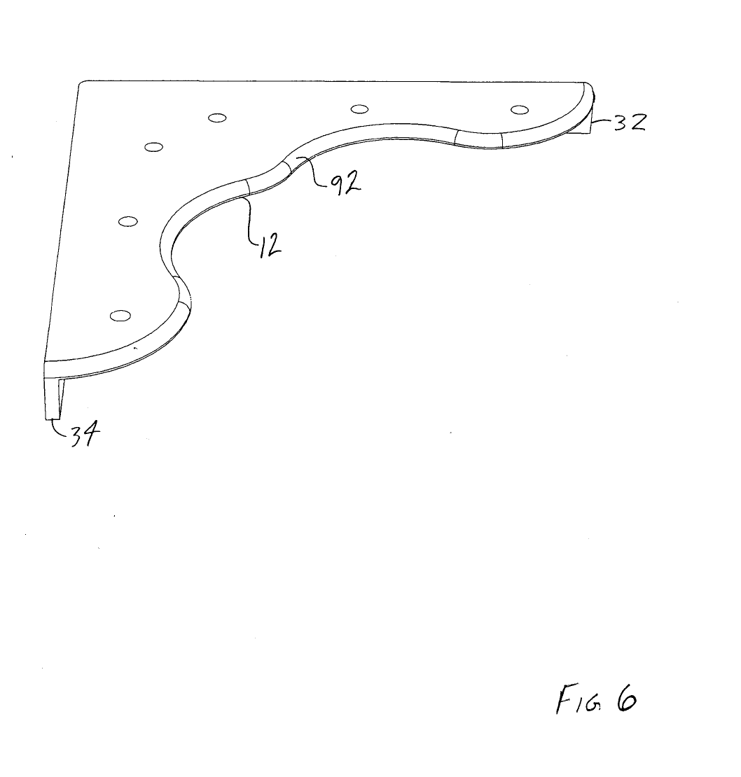

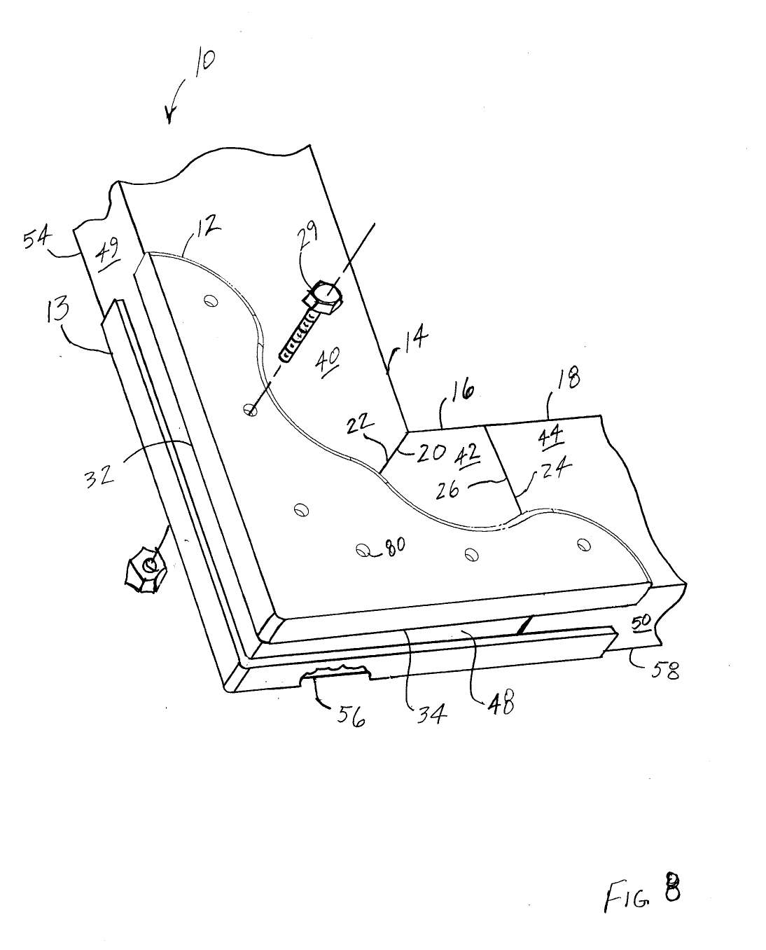

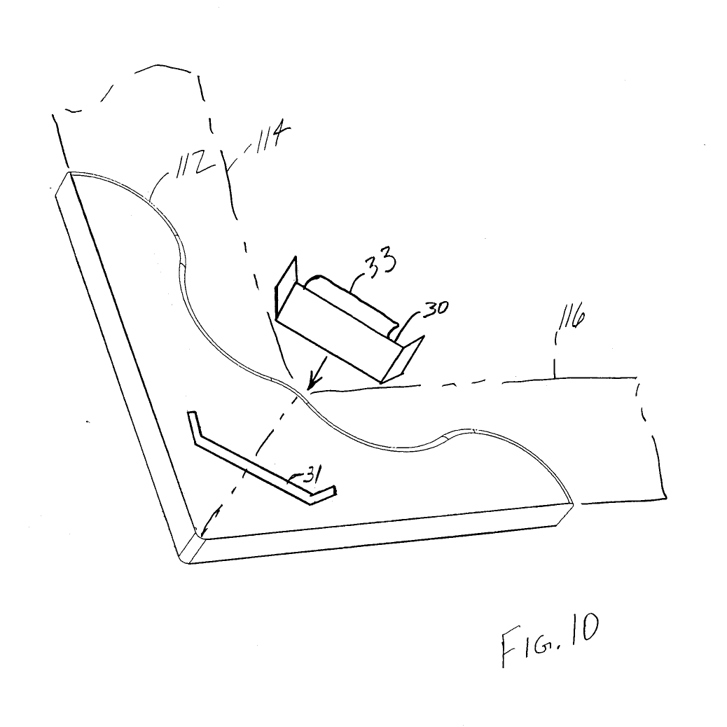

FIGS. 1-8 show an exemplary embodiment of a brace 10 or gusset or bracket, such as a corner bracket for supporting structural members in a predetermined position, such as support members of a gate frame. Brace 10 includes a first body 12 or body having a plurality of apertures 80, such as, for example, six apertures formed therein for receiving a corresponding fastening device 29, such as a nut and bolt (shown in FIG. 8), screw or other suitable mechanical fastener for securing first body 12 to a structural member, such as a structural member 14 (FIG. 8). As further shown in the figures, first body 12 includes a substantially planar first surface 38 configured to abut or provide conformal contact corresponding first surfaces 40, 42, 44 of adjacent structural members 14, 16, 18 (FIG. 8), although in another embodiment, first surface 38 may be nonplanar, for example, to permit conformal contact with corresponding nonplanar first surfaces of adjacent structural members. In one embodiment, structural members 14, 16, 18 are secured to first surface 38 of first body 12 by one or more fastening devices 29, 30 (fastening device 30 shown in FIG. 10). In another embodiment, an adhesive (not shown) may be used by itself or in combination with one or more fastening devices 29, 30 to secure structural members 14, 16, 18 to first surface 38. As further shown in FIG. 1, retention features 28 extending outwardly from first surface 38, such as elongate tapered protrusions may be used to secure structural members 14, 16, 18 to first surface 38 of first body 12. Stated another way, an exemplary embodiment of the brace can include only a substantially planar (or alternately, nonplanar as previously discussed) first body 12, if desired.

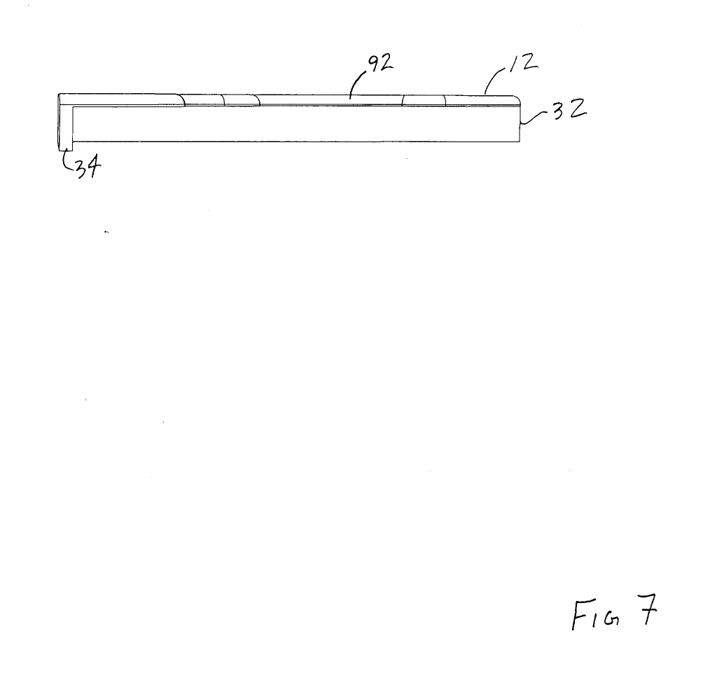

Alternately, as further shown in the figures, first body 12 can include flanges 32, 34 positioned at a predetermined angle 36 therebetween, such as a 90 degree angle. However, in other embodiments, flanges 32, 34 may be positioned at angles different than 90 degrees. As further shown in the figures, flange 34 extends outwardly in a substantially perpendicular direction away from first surface 38, although in another embodiment, flange 34 can extend outwardly away from first surface 38 in a non-perpendicular direction. Flange 34 includes a second surface 46 facing first surface 38. As further shown in the figures, flange 32 extends outwardly in a substantially perpendicular direction away from first surface 38, although in another embodiment, flange 32 can extend outwardly away from first surface 38 in a non-perpendicular direction. Flange 32 includes a third surface 51 facing first surface 38. As further shown in the figures, flanges 32, 34 intersect at a corner 35 and define a continuous second surface 46 transitioning to a third surface 51, although in another embodiment, flanges 32, 34 may not intersect, forming a discontinuity or spacing therebetween (not shown). As further shown in the figures (see FIG. 7), flanges 32, 34 have a substantially equal width, although in other embodiments the widths of flanges 32, 34 may be different from each other. In a further embodiment, at least a portion of one or more of flanges 32, 34 can include retention feature 28. In yet a further embodiment, apertures, such as aperture 80 may be formed in flanges 32, 34 to receive a fastening device, such as fastening device 29, 30.

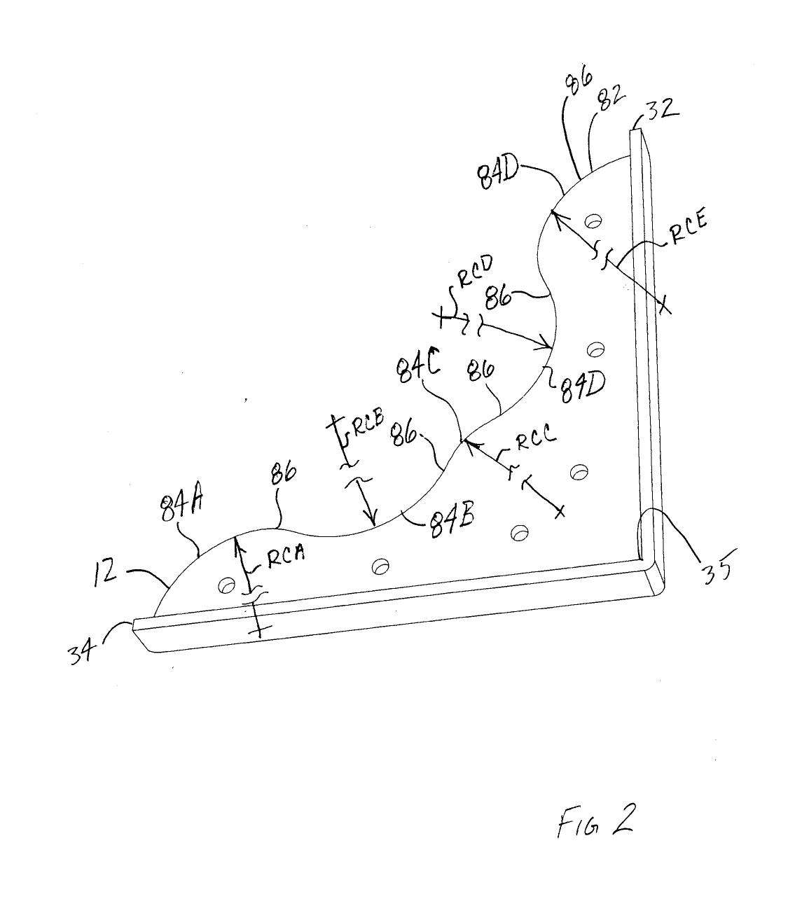

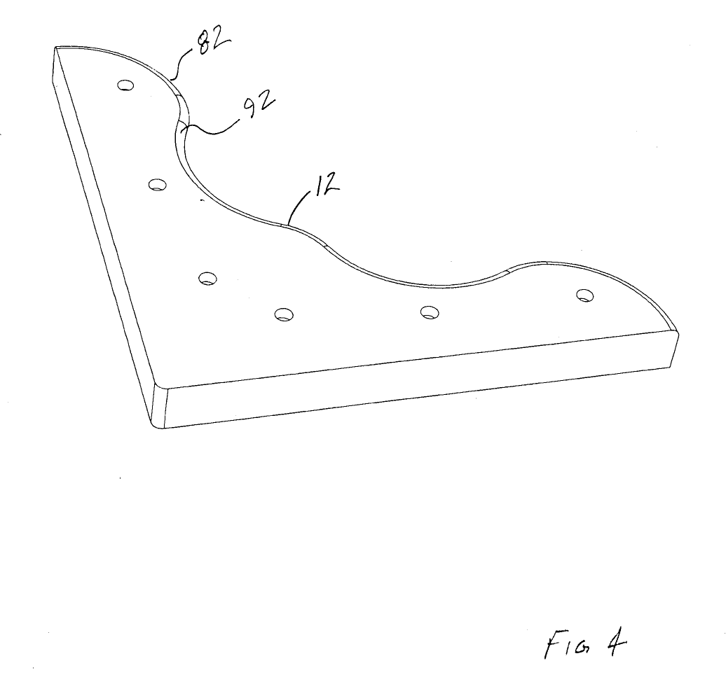

As further shown in FIGS. 1-4, first body 12 has a substantially triangular shape, with each of flanges 32, 34 substantially corresponding to a leg of the triangle. A curved line 82 extends between ends or regions near the ends of respective flanges 32, 34 opposite corner 35, defining an aesthetically pleasing construction of first body 12. As further shown in FIG. 4, curved line 82 includes a tapered edge 92, which taper can define a curved profile, a beveled profile, or a profile having a combination thereof. As further shown in FIG. 2, from an end of flange 32 toward an end of flange 34, each flange end opposite corner 35, curved line 82 defines an arrangement of curved line segments 84A, 84B, 84C, 84D having respective radii of curvature RCA, RCB, RCC, RCD separated by transition regions 86. As further shown in FIG. 2, the general center of respective radii of curvature RCA, RCB, RCC, RCD alternate between extending toward body 12 and away from body 12. As further shown in FIG. 1, a line segment 88 extends from corner 35 and bisects angle 36. Line segment 88 and corner 35 define a plane 90. In an exemplary embodiment, plane 90 divides brace 10 into two halves that are mirror images of each other. In other embodiments, the brace will not have symmetric halves. It is to be understood that any of the curved line segments 84A, 84B, 84C, 84D may have more than one radius of curvature along a particular portion of any of the line segments. For example, curved line segment 84A is not limited to radii of curvature RCA to define the path of curved line segment 84A, and that the term radii of curvature and associated symbology RCx is utilized to help describe the general profile of curved line 82, and is not intended to be limiting of the path traced by curved line 82. In another embodiment, not only may curved line segments 84A, 84B, 84C, 84D each have differing radii of curvature, but in yet a further embodiment, there may be more or less than for curved line segments.

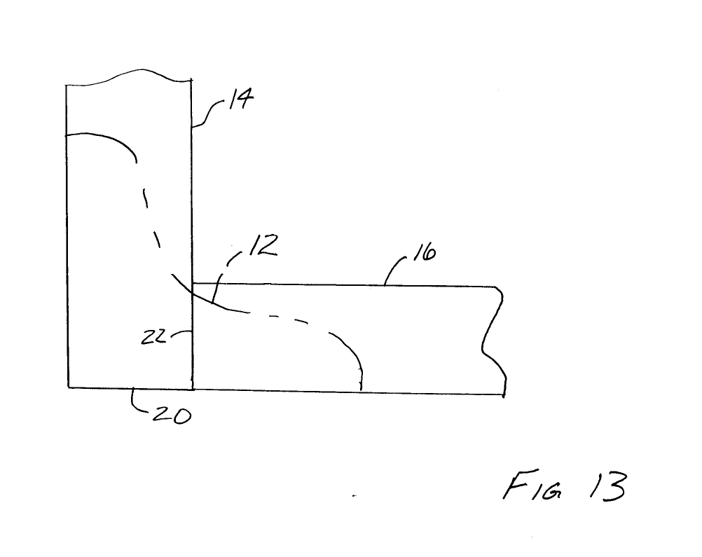

Further referring to FIGS. 1-9, especially in view of FIG. 8, operation of brace 10 is now discussed. Brace 10, including first body 12, and optionally second body 13, secures ends 20, 22 of respective adjacent structural members 14, 16, such as securing ends 20, 22 together. In an alternate embodiment, as shown in FIG. 13, ends 20, 22 of respective structural members 14, 16 are secured, but ends 20, 22 are secured at a predetermined arrangement near each other, but not in abutting contact with each other. The term together is intended to include arrangements in which the ends of adjacent structural members are in abutting contact, as well as arrangements in which the ends of adjacent structural members are secured near or in close proximity to each other. However, as further shown in FIG. 8, brace 10 is not limited to securing the ends of a pair of adjacent structural members, but may also secure the ends of more than one pair of adjacent structural members. That is, in addition to securing ends 20, 22 of respective adjacent structural members 14, 16, brace 10 can additionally secure ends 24, 26 of respective adjacent structural members 16, 18. For example, sufficiently inserting fastening devices 29 through respective openings 80 of first body 12 urges abutting contact between first surfaces 40, 42, 44 of respective structural members 14, 16, 18 and first surface 38. First body 12 includes flange 34, also referred to as a guide feature, which flange 34 having a second surface 46 (FIG. 1), in which second surface 46 is brought into abutting contact with second surface 48, 50 of respective structural members 16, 18. First body 12 includes flange 32, also referred to as a guide feature, which flange 32 having a third surface 51 (FIG. 1), in which third surface 51 is brought into abutting contact with a second surface 49 of structural member 14.

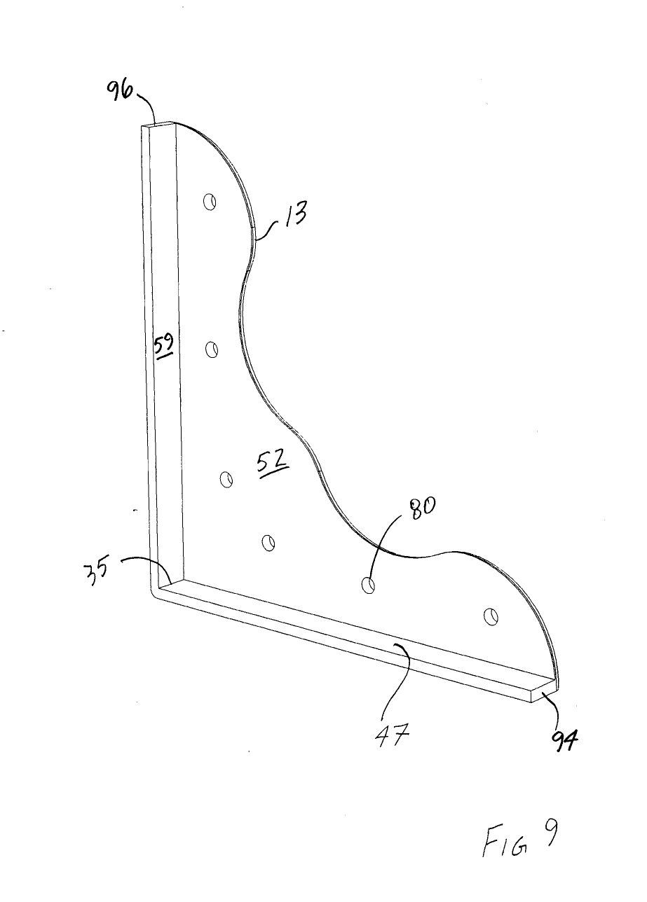

Optionally, if second body 13 of brace 10 is utilized, for example, with fastening devices 29 (e.g., nut and bolt connection) extending through openings 80 of first body 12, through the respective structural member 14, 16, 18, and then through respective openings 80 of second body 13 and upon sufficient actuation of fastening device in one direction, second body 13 is urged into abutting contact between third surfaces 54, 56, 58 of respective structural members 14, 16, 18 and first surface 52 of second body 13. Second body 13 includes a flange 94, also referred to as a guide feature, which flange 94 having a second surface 47 (FIG. 9), in which second surface 47 is brought into abutting contact with second surface 48, 50 of respective structural members 16, 18. Second body 13 includes a flange 96, also referred to as a guide feature, which flange 96 having a third surface 59 (FIG. 9), in which third surface 59 is brought into abutting contact with second surface 49 of structural member 14.

It is to be understood that while flanges 32, 34 of first body 12 and flanges 94, 96 of second body 13 can help provide structural support between respective abutting surfaces of structural members 14, 16, 18 and the flanges, the flanges can also act as guides to align the ends of the structural members, such as ends 20, 22 of respective adjacent structural members 14, 16 that are arranged to form a corner, such as a corner of a gate. That is, third surfaces 51, 59 of respective flanges 32, 96 of respective bodies 12, 13 can act as guides for second surface 49 of structural member 14. Similarly, second surfaces 46, 47 of respective flanges 34, 94 of respective bodies 12, 13 can act as guides for second surface 48 of structural member 16. Although not specifically shown in the figures, it is apparent that the tip of beveled end 20 of structural member 14, as well as the tip of beveled end 22 of structural member 16 would each abut corner 35 of respective bodies 12, 13, substantially preventing over-insertion/under-insertion of the corner structural members in the brace. Alternately for non-beveled ends 20, 22 of respective structural members 14, 16, end 20 of structural member 14 would abut second surfaces 46, 47 of respective flanges 34, 94 of respective bodies 12, 13 while end 22 of structural member 16 would abut third surfaces 32, 96 of respective bodies 12, 13, substantially preventing over-insertion/under-insertion of the corner structural members in the brace.

As shown in FIG. 10, an alternate embodiment of a first body 112 includes an opening 31 configured to receive a fastening device 30 that is configured to engage and say secure the ends of adjacent structural members secured by first body 112, due to the extended width of a fastening device 30. Fastening device 30 further includes a flange 33, permitting collective support of the ends of structural members 114, 116, as well as first body 112. Fastening devices as previously discussed may be used in combination, if desired.

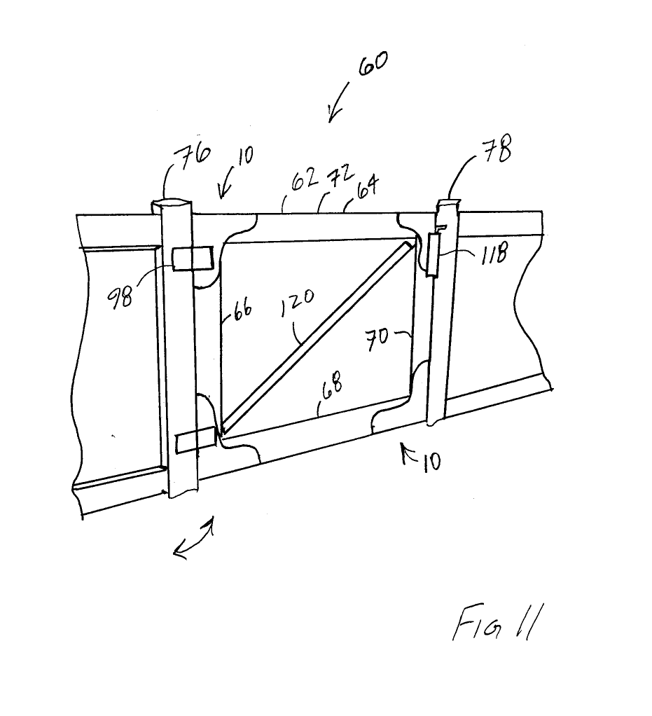

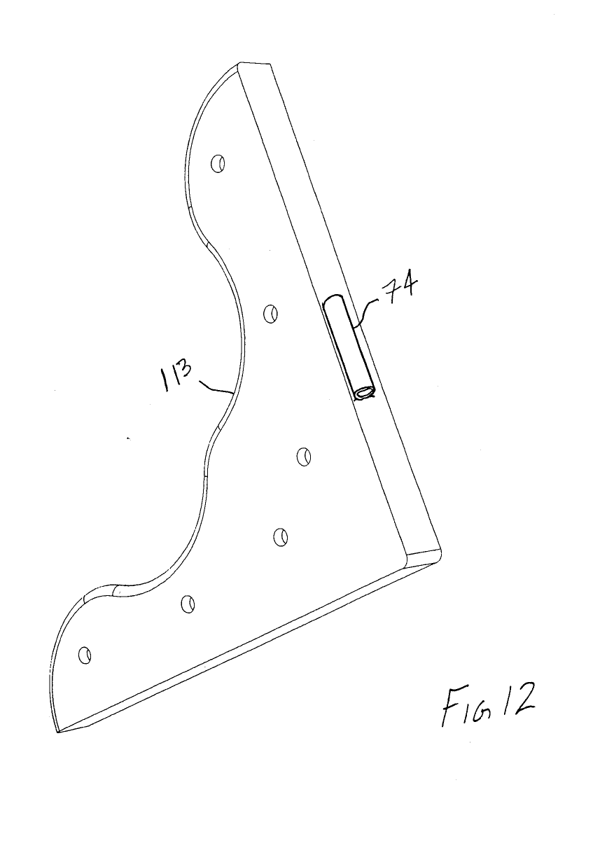

As shown in FIGS. 11-12, a fence system 60 includes a gate 62 supported between opposed posts 76, 78. Gate 62 includes the ends of support members 64, 66, 68, 70, which comprise a frame 72 of gate 62, being supported by braces 10, such as in a manner previously discussed. Gate 62 is pivotably connected to post 76 by hinges 98 at one end of gate 62, and secured to a stop mechanism 118 associated with post 78 at the other end of the gate 62. A diagonal support member 120 may be used if desired.

As further shown in FIG. 12, an embodiment of second body 113 includes a hinge portion 74, permitting second body 113 to form a pivotable connection with a post or other support structure.

It is to be understood that the brace of the present disclosure may be used with, but not limited to, any and all fence, deck and railing date applications including new, existing and previously inoperable applications. It is also to say be understood that the brace of the present disclosure may also be used with other outdoor applications such as outdoor furniture, including, but not limited to, planter boxes shower enclosures, storage sheds, and the like. It is further to be understood that the brace of the present disclosure may be used in conjunction with the multitude of materials such as wood, vinyl, PVC, composite, plastic, aluminum, steel or any other suitable material. It is further to be understood that the number of braces of the present disclosure used in an application can vary. For example, a rectangular structural member can utilize up to two braces per corner, for a total of eight braces. It is to be understood that the brace of the present disclosure is not limited to rectangular structural members having 90 degree corners, but can be used with other geometric shapes, including curved structural members.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A brace comprising:
a first body configured and disposed to secure ends of adjacent structural members together, the brace having a substantially triangular shape.

2. The brace of claim 1, wherein the first body includes retention features formed therein to secure ends of adjacent members together.

3. The brace of claim 1, wherein at least one fastening device extends through an opening formed in the first body, the at least one fastening device configured and disposed to engage adjacent structural members secured by the first body.

4. The brace of claim 3, wherein the first body includes at least two flanges disposed at a predetermined angle from each other to guide ends of adjacent structural members together.

5. The brace of claim 4, wherein two flanges of the at least two flanges substantially correspond to a leg of the substantially triangular shape of the first body.

6. The brace of claim 4, wherein the predetermined angle is about 90 degrees.

7. The brace of claim 3, wherein a first surface of the first body abuts a first surface of each of adjacent structural members.

8. The brace of claim 7, wherein a second surface of the first body abuts a second surface of at least one structural member of adjacent structural members.

9. The brace of claim 8, wherein a first surface of a second body abuts a third surface of each of adjacent structural members.

10. The brace of claim 9, wherein the second body includes at least one fastening device extending through an opening formed in the second body, the at least one fastening device configured and disposed to engage adjacent structural members secured by the second body.

11. The brace of claim 9, wherein the third surface is opposite the first surface of each of adjacent structural members.

12. The brace of claim 1, wherein adjacent structural members form a portion of a frame of a gate.

13. The brace of claim 1, wherein the first body includes a hinge portion.

14. A fence system comprising:
a gate having a plurality of structural members, the gate pivotably connectable to a post;
at least one brace secured to at least two structural members of the plurality of structural members, the at least one brace comprising:
a body configured and disposed to secure ends of the at least two structural members together, the at least one brace having a substantially triangular shape.

15. The fence system of claim 14, wherein at least one brace of the at least one brace includes a hinge portion.

16. A method for reinforcing a fence gate comprising:
providing at least one brace; and
securing ends of at least two adjacent structural members of a frame of the gate to the at least one brace.

17. The method of claim 16, further comprising guiding the at least one brace to a position for securing ends of at least two adjacent structural members of a frame of the gate using a guide feature formed in the at least one brace.

18. The method of claim 16, wherein securing ends includes securing ends of at least two adjacent structural members of a frame of the gate to the at least one brace, the at least one brace comprising a first body and an opposed second body.

19. The method of claim 16, wherein the fence gate is selected from the group consisting of vinyl, wood, plastic, composite, aluminum, steel, and PVC and combinations thereof.

20. The method of claim 16, wherein securing ends includes inserting at least one fastening device through an opening formed in the at least one brace, the at least one fastening device configured and disposed to engage adjacent structural members positioned in the at least one brace.
